(19) United States
(12) Patent Application Publication
(10) Pub. No.: US 2024/0300782 A1
(43) Pub. Date: Sep. 12, 2024

(54) CRANE VEHICLE

(71) Applicant: TADANO LTD., Kagawa (JP)

(72) Inventors: Rika TSUKURA, Kagawa (JP); Kei Ohara, Kagawa (JP)

(73) Assignee: TADANO LTD., Kagawa (JP)

(21) Appl. No.: 18/589,476

(22) Filed: Feb. 28, 2024

(30) Foreign Application Priority Data
Mar. 7, 2023 (JP) 2023-035015

(51) Int. Cl. B66C 13/48; B66C 13/46; B66C 23/78

(52) U.S. Cl. CPC B66C 13/48; B66C 13/46; B66C 23/78

(57) ABSTRACT

A crane has a traveling device, a turn table, a cockpit, a main power unit, an auxiliary power unit, and a processor that selectively switches between a manual power mode and an auxiliary power mode, and the processor disables a switching between the manual power mode and the auxiliary power mode when an operation input to the operating system that operates the boom is detected, and the processor enables a switching between the main power mode and the auxiliary power mode when an operation input to the operating system is not detected.

### CROSS REFERENCE TO RELATED APPLICATIONS

This application is entitled to or claims the benefit of Japanese Patent Application No. 2023-035015, filed on Mar. 7, 2023, the disclosure of which including the specification, drawings and abstract is incorporated herein by reference in its entirety.

### TECHNICAL FIELD

The present invention relates to a crane vehicle.

### BACKGROUND ART

A self-propelled crane vehicle, such as a rough terrain crane, has a traveling device, a turn table, and a boom (including a jib) which serves as a crane portion. The traveling device is a vehicle body having equipment for traveling, and has an engine that is the power source for traveling and crane work with a boom, traveling wheels or the like that transmit the power of the engine to the road surface, and outriggers or the like for improving stability during work on the carrier frame which serves as the backbone. The turn table is disposed above the traveling device and is turnable in the horizontal plane with respect to the traveling device. The turn table is driven by an engine installed in the traveling device.

The boom is installed on the turn table and turns with the turn table with respect to the traveling device. The crane vehicle raises and lowers the load or moves the load to another position by extending and retracting the boom, raising and lowering the boom with respect to the turn table and turning the turn table, and winding up and unwinding the suspended load wire with the winch. The crane vehicle is operated by the operator in the cockpit (cabin) on the turn table, who operates the crane during traveling and operates the crane work with the boom.

By the way, it is required that a crane vehicle should reduce emissions of greenhouse gases such as carbon dioxide (CO₂) by shutting down the engine when the crane vehicle is not traveling or crane work is not being performed. On the other hand, it is required for the crane vehicle that the air conditioning device (air conditioner) in the cockpit and other accessory power sources (e.g., electric power supplied to the Universal Serial Bus (USB; registered trademark) terminal, etc.) operate for the convenience of the operator, even when the engine is stopped.

Therefore, it is proposed that the crane vehicle has an auxiliary power unit (APU) separate from the engine installed in the traveling device for traveling and the crane work (hereinafter referred to as “vehicle engine”). The APU mainly provides electric power used in the cockpit during periods when the vehicle engine is stopped. For example, the APU provides electric power for air conditioning in the cockpit and accessory components used in the cockpit, such as monitors and USB (registered trademark) terminals.

By the way, in a case where power is supplied by the vehicle engine, when the power supply is switched to the APU in a state where the operation for crane work is being performed, i.e., there is some input to the actuator for crane work, the power supplied to the boom and the winch is cut off, which may cause the boom and winch to stop moving abruptly. On the contrary, in a case where the power is supplied by the APU, when the power supply is switched to the vehicle engine in a state where there is some input to the actuator for crane work, the stopped boom or the stopped winch may suddenly start moving.

Therefore, it is required to prevent changes in the movement of the crane, such as the boom and the winch, when the power to be supplied is switched between the vehicle engine and the APU.

Here, in an elevating work vehicle that switches between the main power source and the auxiliary power source for use, a control device that regulates manual switching of the power supply by the operator between the main power source and the auxiliary power source by informing the operator of a drop in the power supply voltage has been proposed (see, for example, Patent Literature 1).

### CITATION LIST

### Patent Literature

Patent Literature 1: Japanese Patent Application Laid-Open No. 1982-190200

### SUMMARY OF THE INVENTION

### Problems to be Solved by the Invention

However, the technology in the Patent Literature 1 only informs the operator of a drop in power supply voltage and does not limit switching between the main power source and the auxiliary power source. The technology in the Patent Literature 1 allows the boom to be moved either by the supply of the main power source or by the supply of the auxiliary power source, and there is no difference in functionality for the boom between the main power source and the auxiliary power source.

The purpose of the present invention is to provide a crane vehicle that can prevent changes in the movement of the crane, such as the boom and the winch, when the power to be supplied is switched between the vehicle engine and the APU.

### Solution to Problem

One aspect of the crane vehicle according to the present invention includes: a traveling device; a turn table that is disposed above the traveling device and turnable with respect to the traveling device; a boom and a cockpit that are provided on the turn table; a main power unit that is provided in the traveling device and supplies power to the traveling device, the boom and the cockpit; an auxiliary power unit that is provided on the turn table and does not supply power to the traveling device and the boom, but supplies power to the cockpit; and a processor that selectively switches between a main power mode supplied with power from the main power unit and an auxiliary power mode supplied with power from the auxiliary power unit, wherein the processor disables a switching between the main power mode and the auxiliary power mode when an operation input to an operating system that operates the boom is detected, and the processor enables a switching between the main power mode and the auxiliary power mode when an operation input to the operating system is not detected.

### Effects of the Invention

The crane vehicle according to the present invention prevents changes in the movement of the crane, such as the boom and the winch, when the power to be supplied is switched between the vehicle engine and the APU.

### BRIEF DESCRIPTION OF DRAWINGS

FIG. 1 is a diagonal view of a rough terrain crane viewed from the front right;

FIG. 2 is a diagonal view of the rough terrain crane viewed from the left rear;

FIG. 3 is a block diagram illustrating the configuration of the power control device provided by the rough terrain crane;

FIG. 4 is a flowchart illustrating one example of the movement of the power control device in Example 1;

FIG. 5 is a flowchart illustrating one example of the movement of the power control device in a variation of Example 1;

FIG. 6 is a flowchart (Part 1) illustrating one example of the movement of the power control device in Example 2; and

FIG. 7 is a flowchart (Part 2) illustrating one example of the movement of the power control device in Example 2.

### DESCRIPTION OF EMBODIMENTS

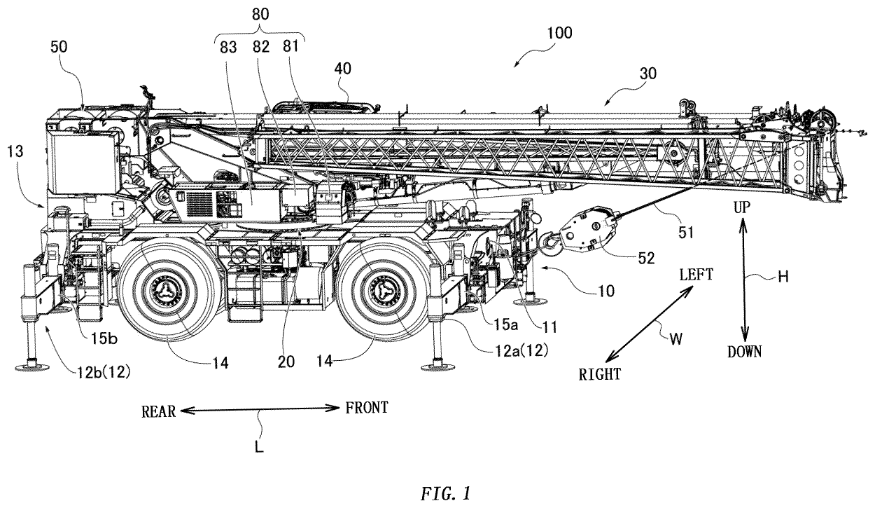

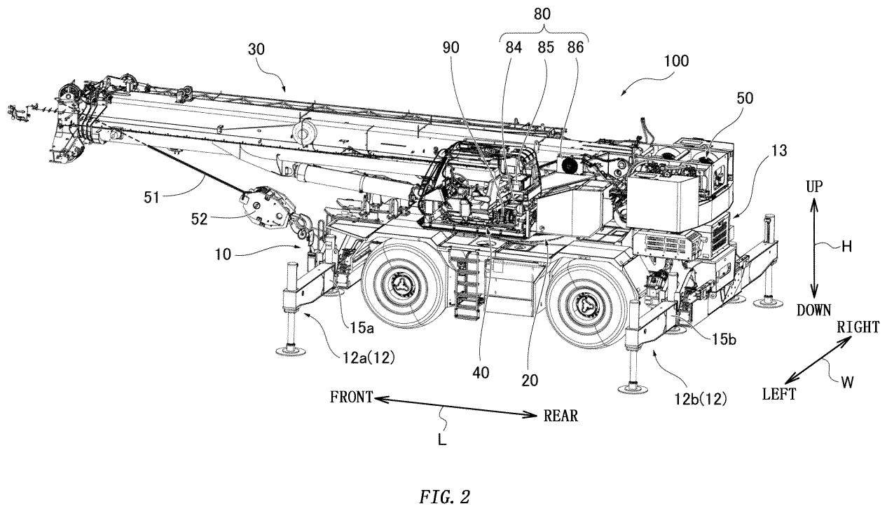

Embodiments of the crane vehicle according to the present invention are described below with reference to the drawings. FIG. 1 is a diagonal view of the rough terrain crane 100 viewed from the front right, and FIG. 2 is a diagonal view of the rough terrain crane 100 viewed from the rear left. The rough terrain crane 100 illustrated in the drawings is one embodiment of the crane vehicle according to the present invention.

### Overall Configuration of Crane

A rough terrain crane 100 (hereinafter simply referred to as “crane 100”), as illustrated in FIG. 1, has a traveling device 10, a turn table 20, a boom 30, a cockpit (cabin) 40, and a winch 50. The crane 100 has a vehicle engine 13 (main power unit) installed in the traveling device 10, an auxiliary power unit (APU) 80 that is separate from the vehicle engine 13 and serves as another power unit, and a power control device 90.

The traveling device 10 is a vehicle body having equipment for traveling on a road or other ground. The traveling device 10 has a carrier frame 11 that serves as the backbone of the vehicle body, a vehicle engine 13, wheels 14, outriggers 12, and the like.

The vehicle engine 13 is provided at the rear of the carrier frame 11 in the front-back direction L. The vehicle engine 13 is, for example, an internal combustion engine (diesel engine) that generates power using light oil as fuel and provides power to the traveling device 10 for traveling. The vehicle engine 13 supplies power for crane work to the boom 30, the winch 50, the turn table 20, and the outriggers 12, respectively, via the PTO. When the output to the vent solenoid is turned off, the operation for crane work is stopped by stopping the venting or by outputting to the prounital valve of each crane actuator to relieve it individually.

The power generated by the vehicle engine 13 is converted into electric power by a generator attached to the vehicle engine 13, and the electric power is supplied to the electrical systems in the traveling device 10, the cabin 40, etc. to operate each of them. The generator of the vehicle engine 13 outputs electric power with a voltage of 48 V, for example.

The electrical systems in the cabin 40 that are supplied with electric power generated by the generator of the vehicle engine 13 include, for example, an air conditioning device (air conditioner) in the cabin 40, a monitor device (MFD: multi-function display) that displays the operating status (e.g., boom 30 posture) and load state such as load rate, etc. of the crane work, accessory components such as a USB (registered trademark) terminal to which various devices are connected, a power control device 90, and various types of sensors that detect the presence or absence of operation inputs to the operating systems installed in the cabin 40 for the crane work.

The wheels 14 are provided on the left and right of the carrier frame 11 in the vehicle width direction W and on the front and rear of the carrier frame 11 in the front-back direction L, between the front and rear outriggers 12a, 12b, respectively, which are described below. The wheels 14 transmit the power of the vehicle engine 13 to the ground and rotate, thereby causing the traveling device 10 to travel.

The outriggers 12 have front outriggers 12a near the front wheels 14 and rear outriggers 12b near the rear wheels 14. The outriggers 12 move between the outstretched and retracted states by the power generated by the vehicle engine 13. Each of the outriggers 12a and 12b has an outreach amount sensor 15a and 15b to detect the amount of outreach of each outrigger. The outreach amount sensors 15a and 15b operate in the vehicle engine mode described below since the outreach amount sensors 15a and 15b are operated by the electric power supplied from vehicle engine 13, and do not operate in the APU mode since the outreach amount sensors 15a and 15b are not supplied with electric power by the APU 80.

In the outstretched state, each of the outriggers 12a and 12b outstretches outward from the carrier frame 11 in the vehicle width direction W and touches the ground to prevent traveling by the wheels 14 and to stabilize the posture of the vehicle body of the crane 100 during crane work in which a suspended load is raised, lowered, or moved by the boom 30. In the retracted state, each of the outriggers 12a and 12b retracts inward in the vehicle width direction W and is away from the ground upward to allow traveling by the wheels 14.

The turn table 20 is disposed above the carrier frame 11, approximately in the center of the front-back direction L. The turn table 20 is provided in such a manner that its center of rotation is aligned with the center of the vehicle width direction W of the traveling device 10, and is provided to be turnable in the horizontal plane around the center of rotation with respect to the traveling device 10. The turn table 20 turns by being driven by the vehicle engine 13.

The boom 30, the winch 50, and the cabin 40 are provided on the turn table 20, and turn in conjunction with the turn table 20 with respect to the traveling device 10. The boom 30 extends and retracts by extending and retracting the internal extension and retraction cylinders, and raises and lowers by extending and retracting the internal raising and lowering cylinders. The extension and retraction of the extension and retraction cylinders and the extension and retraction of the raising and lowering cylinders are performed by the power supplied from the vehicle engine 13 via the PTO.

The winch 50 lowers the hook unit 52 suspended by the wire 51 by unwinding the wound wire 51 and raises the hook unit 52 by winding up the wire 51. The winding up and unwinding of the wire 51 by the winch 50 is performed by the power supplied from the vehicle engine 13 via the PTO.

The crane 100 then raises and lowers the load or changes the position of the load by extending and retracting the boom 30, raising and lowering the boom, winding up or unwinding the wire 51, and turning the turn table 20 in a state that the load is hung on the hook unit 52.

The cabin 40 is provided on the left side in the vehicle width direction W with respect to the boom 30 in the crane 100 of the present embodiment, and may also be provided on the right side with respect to the boom 30.

### APU

The APU 80 is provided in the turn table 20 or in the cabin 40, etc., which turns with the turn table 20. The APU 80 provides power during the period when the vehicle engine 13 is stopped and mainly provides electric power used in the cabin 40. Since the APU 80 is not connected to the traveling device 10, the crane 100 cannot be driven to travel by the power of the APU 80, and since the APU 80 does not have a PTO, the APU 80 does not provide power or electric power for crane work, such as operating the boom 30, the winch 50 and the turn table 20.

The electrical systems in the cabin 40 that are supplied with electric power by the APU 80 include, for example, the air conditioning device in the cabin 40, a monitor device that displays the operating status (e.g., boom 30 posture) and load state such as load rate, etc. of the crane work, accessory components such as a USB (registered trademark) terminal to which various devices are connected, a power control device 90, and various types of sensors that detect the presence or absence of operation inputs to the operating systems installed in the cabin 40 for the crane work.

The APU 80, as an example, has a main body 81, electrical system components 82 including a battery and a DC-DC converter, a fuel tank 83, an APU controller 84, an evaporator 85, and a capacitor 86.

The main body 81 is a diesel engine as an example, and the main body 81 is not limited to a diesel engine as long as the main body 81 is a power source that generates electric power. In addition to the diesel engine, the main body 81 may be a storage battery, specifically, or a power receiving output unit that receives and outputs electric power from an external source. The diesel engine (sub-engine) as the main body 81 is more compact than the vehicle engine 13, consumes less fuel (e.g., fuel consumption per unit output) than the vehicle engine 13, and is more efficient in fuel consumption (more fuel efficient) than the vehicle engine 13. Thus, the APU 80 reduces fuel consumption and carbon dioxide emissions as compared to the vehicle engine 13.

A fuel tank 83 is a tank that stores fuel to drive the sub-engine. Therefore, in a case where the main body 81 is not an internal combustion engine, such as a diesel engine, and does not require fuel, the APU 80 does not have the fuel tank 83. The crane 100 also has a tank storing fuel to drive the vehicle engine 13, separate from the fuel tank 83, in the traveling device 10. Therefore, even in a case where the APU 80 supplies fuel from the fuel tank provided in the traveling device 10 to the sub-engine to drive the sub-engine, the APU 80 does not have the fuel tank 83.

The battery in the electrical system components 82 starts the sub-engine, and is charged with and stores the electricity generated while the sub-engine is being driven. The DC-DC converter in the electrical system components 82 boosts the voltage of the electric power generated by the sub-engine to the voltage of the electric power generated by the generator of the vehicle engine 13.

The voltage of the electric power generated by the generator of vehicle engine 13 is set to 24 [V] as an example, and therefore, the electrical systems in the cabin 40, such as the air conditioning device, the monitor device, the power control device, and the USB (registered trademark) power supply, are set to operate at a voltage of 24 [V]. On the other hand, the voltage of the electric power generated by the sub-engine is set to 12 [V] as an example.

Therefore, the DC-DC converter in the electrical system components 82 boosts the voltage of the electric power generated by the generator of the sub-engine to the voltage of 24 [V] of the electric power generated by the generator of the vehicle engine 13 in order to use this voltage of 12 [V] in the electrical equipment installed in the cabin 40. Therefore, in a case where the voltage of the electric power generated by the generator of the sub-engine is the same as the voltage of the electric power generated by the generator of vehicle engine 13, the APU 80 does not have the DC-DC converter in the electrical system components 82.

The APU controller 84, the evaporator 85, and the condenser 86 provide air conditioning in the cabin 40, powered by the sub-engine. A separate air conditioning device in the cabin 40 is powered by the vehicle engine 13. In other words, the crane 100 has two air conditioning devices: an air conditioning device (main air conditioner) powered by the vehicle engine 13 in the traveling device 10 and an air conditioning device (sub-air conditioner; APU controller 84, evaporator 85 and capacitor 86) powered by the sub-engine.

The air conditioning device for the cabin 40 is then selected as the main air conditioner in the vehicle engine mode, where the vehicle engine 13 is driven, and is selected as the sub air conditioner in the APU mode, where the APU 80 is driven. The air conditioning in the cabin 40 is then performed by the selected air conditioning device.

In the present embodiment, the APU controller 84, the evaporator 85, and the capacitor 86, which are not the main components of the APU 80 are disposed on the left side with respect to the boom 30, the same as the cabin 40.

The APU controller 84, the evaporator 85, and the condenser 86 are preferably disposed close to the cabin 40 to perform air conditioning inside the cabin 40, as described above. In particular, the evaporator 85 is disposed inside the cabin 40 since the evaporator 85 is a heat exchanger in the cabin 40. The APU controller 84 is disposed inside the cabin 40, the same as the evaporator 85, since the APU controller 84 includes electronic components and is required not to be exposed to water, such as rain or snow, and to the outside air, which is at a higher temperature. The condenser 86 is disposed outside the cabin 40 to perform the heat exchange which is the opposite of the heat exchange required inside the cabin 40.

The APU controller 84 performs control of the operation of the sub air conditioner, control of the drive of the main body 81, control of the drive of the pump of the fuel tank 83, control of the operation of the electrical system components (DC-DC converter, battery) 82, control of the operation of the monitor device, and control of the electric power supply to accessory components such as the USB (registered trademark) terminal installed inside the cabin 40 (accessory power supply). The APU controller 84 is a hardware processor such as a central processing unit (CPU) that performs the various controls described above.

### EXAMPLE 1

### Power Control Device

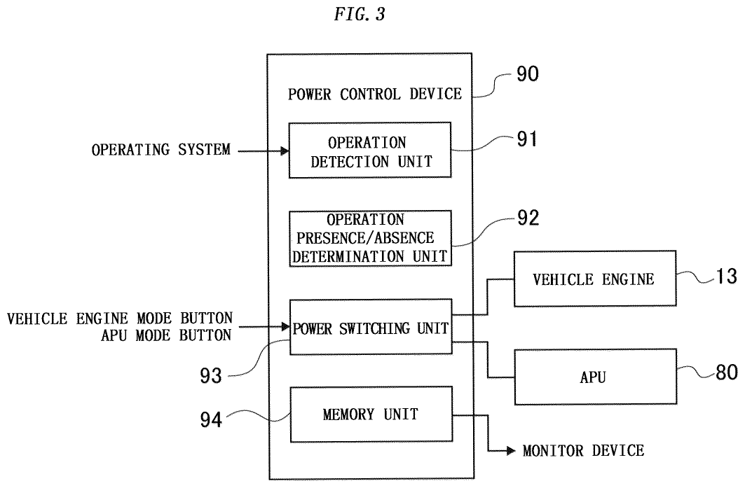

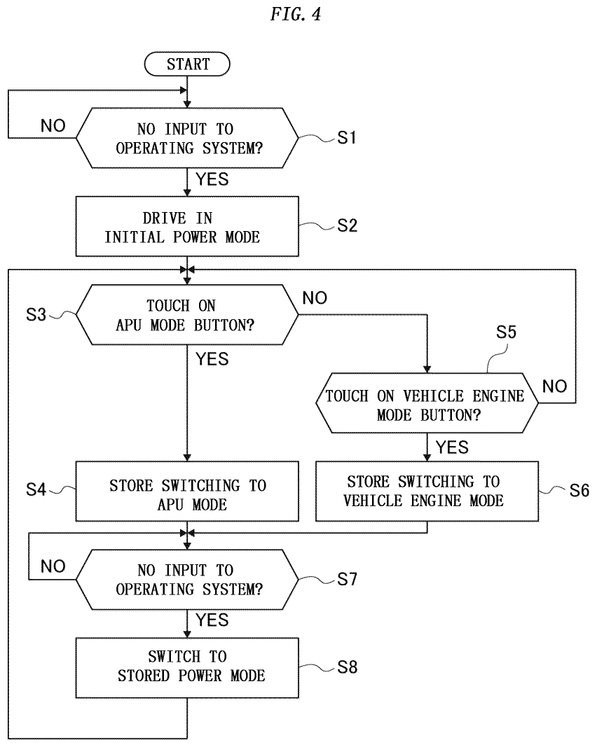

FIG. 3 is a block diagram illustrating the configuration of the power control device 90 of Example 1 in which the crane 100 illustrated in FIGS. 1 and 2 is included, and FIG. 4 is a flowchart illustrating one example of the operation of the power control device 90 of Example 1.

The power control device 90 of Example 1 performs control on the crane 100 by selectively switching between supplying power by the vehicle engine 13 and supplying power by the APU 80. The power control device 90 has an operation detection unit 91, an operation presence/absence determination unit 92, a power switching unit 93, and a memory unit 94, as illustrated in FIG. 3. The functions of the power control device 90 are realized, for example, by a computer. The operation detection unit 91, the operation presence/absence determination unit 92, and the power switching unit 93 are hardware processors, such as a CPU, and the memory unit 94 is a memory such as a read only memory (ROM) and a random access memory (RAM).

The power control device 90 operates with electric power supply from the vehicle engine 13 in the vehicle engine mode or with electric power supply from the APU in the APU mode. The power control device 90 performs calculations of the load state of the crane 100, as well as other operations described below.

The power control device 90 is provided in the cabin 40. The monitor device is provided in the cabin 40. The monitor device is a touch panel type, for example, and when an operator touches a button icon displayed on the monitor device, the function set for that icon is executed.

In addition to the operating status (e.g., boom 30 posture) and load state of the crane work described above, the monitor device displays an icon for the vehicle engine mode button indicating the vehicle engine mode (main power mode) and an icon for the APU mode button indicating the APU mode (auxiliary power mode). The icon for the vehicle engine mode button is the switch corresponding to the vehicle engine mode, and the icon for the APU mode button is the switch corresponding to the APU mode.

The switch corresponding to the vehicle engine mode or the APU mode is not limited to the icon for the vehicle engine mode button or the icon for the APU mode button displayed on the monitor device, and can also be a mechanical switch that physically switches on and off. The mechanical switch may be a single switch that selectively switches between the vehicle engine mode and the APU mode, instead of two separate switches, one to turn the vehicle engine mode on and off and one to turn the APU mode on and off.

The vehicle engine mode is a power mode that drives the vehicle engine 13 and supplies power or electric power generated by the vehicle engine 13 to the crane 100, and the APU mode is a power mode that drives the APU 80 and supplies power or electric power generated by the APU 80 to the crane 100.

The vehicle engine mode not only can supply electric power to the cabin 40, but also can allow the traveling device 10 to drive the crane 100 to travel and perform crane work that operates the boom 30 or the winch 50. On the other hand, the APU mode can supply electric power to the cabin 40, but cannot drive the crane 100 to travel or perform crane work.

When the icon for the vehicle engine mode button is touched (vehicle engine mode is selected as the power mode), the power control device 90 switches the power supplied to the crane 100 to power supplied by the vehicle engine 13 according to predetermined conditions, and when the icon for the APU mode button is touched (APU mode is selected as the power mode), the power control device 90 switches the power supplied to the crane 100 to power supplied by the APU 80 according to the predetermined conditions. The predetermined conditions are, for example, that there is no input to the operating system for crane work, which is described below.

The operation detection unit 91 of the power control device 90 detects the presence or absence of an input to the operating system for crane work. The operating system for crane work includes, for example, a raising and lowering operation lever that operates the raising and lowering movement of the boom 30, an extension and retraction operation lever that operates the extension and retraction movement of the boom 30, a winch operation lever that operates the unwinding movement and the winding up movement of the winch 50, and operation pedals that operate the movement speed of each movement corresponding to each of these operation levers.

Therefore, the operation detection unit 91 detects the presence or absence of an operation input to the raising and lowering operation lever or the raising and lowering operation pedal to perform the raising and lowering movement and to adjust the speed of the raising and lowering movement, detects the presence or absence of an operation input to the extension and retraction operation lever or the extension and retraction operation pedal to perform the extension and retraction movement and to adjust the speed of the extension and retraction movement, detects the presence or absence of an operation input to the winch operation lever to perform the unwinding or winding up movement of the wire 51 and to adjust the speed of that movement, and detects the presence or absence of an operation input to the turning lever to perform a turning movement of the turn table 20 and to adjust the speed of the turning movement.

The operation detection unit 91 may detect the presence or absence of an operation input to these operating systems by acquiring an output signal from a detection sensor provided in advance in the respective operating system, or the detection sensor provided in advance in the respective the operating system may be used as the operation detection unit 91.

The operation presence/absence determination unit 92 of the power control device 90 determines whether the detection result of the operation detection unit 91 indicates that there is no input for all operating systems, or whether there is an input for at least one of all operating systems, and outputs the result. In a case where there is no input for all operating systems, there is no operation input to all of the raising and lowering operation lever, the raising and lowering operation pedal, the extension and retraction operation lever, the extension and retraction operation pedal, the winch operation lever, the winch operation pedal, and the turning lever.

On the other hand, in a case where there is an input for any one of all operating systems, there is an operation input for at least one of the raising and lowering operation lever, the raising and lowering operation pedal, the extension and retraction operation lever, the extension and retraction operation pedal, the winch operation lever, the winch operation pedal and the turning lever.

The power switching unit 93 of the power control device 90 can switch from the vehicle engine mode to the APU mode or from the APU mode to the vehicle engine mode when the operation presence/absence determination unit 92 determines that there is no operation input to all operating systems.

The power switching unit 93 stops the vehicle engine 13 that is being driven and drives the APU 80 that is stopped in such a manner that in the vehicle engine mode supplied with power by the vehicle engine 13, when the APU mode button on the monitor device is touched, the power switching unit 93 actually switches from the vehicle engine mode to the APU mode in a state that allows switching from the vehicle engine mode to the APU mode, as described above.

The power switching unit 93 stops the APU 80 that is being driven and drives the vehicle engine 13 that is stopped in such a manner that in the vehicle engine mode supplied with power by the APU 80, when the vehicle engine mode button on the monitor device is touched, the power switching unit 93 actually switches from the APU mode to the vehicle engine mode in a state that allows switching from the APU mode to the vehicle engine mode, as described above.

On the other hand, the power switching unit 93 of the power control device 90 mutually prevents switching of the power mode between the vehicle engine mode and the APU mode when the operating system input is determined to be present by the operation presence/absence determination unit 92.

Therefore, when the power switching unit 93 prevents switching of the power mode, even when the APU mode button on the monitor device is touched or the vehicle engine mode button is touched, switching of the power mode is disabled and the vehicle continues to be driven in the current power mode.

The memory unit 94 stores the outreach amount of each outrigger 12a and 12b detected by the outreach amount sensors 15a and 15b in the vehicle engine mode.

The operation of the power control device 90 described above is illustrated with reference to the flowchart illustrated in FIG. 4.

The crane 100 starts when the vehicle engine mode or APU mode is selected and a power source is turned on. In this process of starting the crane 100, either the vehicle engine 13 is driven and a power source is turned on by the power supply from the vehicle engine 13 in the vehicle engine mode, or the APU 80 is driven and a power source is turned on by the power supply from the APU 80 in the APU mode. The supply of power by the vehicle engine 13 or by the APU 80 supplies electric power to the power control device 90, thereby activating the power control device 90.

At the beginning after the start when the power source is turned on, the operation detection unit 91 detects the presence or absence of the input to the operating system described above (S1 in FIG. 4). In other words, the power control device 90 checks that the operating system of the crane work is not in an operating state that allows the crane work to be performed when the crane 100 is started.

As a result of the detection by the operation detection unit 91, when the operation presence/absence determination unit 92 determines that there is no operation input to all operating systems (YES in S1), the power switching unit 93 controls to drive (supply power) in the initially selected power mode (vehicle engine mode or APU mode) (S2). When the power switching unit 93 switches to supply power in the vehicle engine mode, crane work is possible as long as the PTO is turned on and the PTO is connected to the vehicle engine 13.

On the other hand, as a result of the detection by the operation detection unit 91, when the operation presence/absence determination unit 92 determines that there is an operation input to one of the operating systems (NO in S1), the power switching unit 93 does not control to drive (supply power) in the initially selected power mode (vehicle engine mode or APU mode), but instead stands by until it is determined that there is no operation input to all operating systems (process of S1 is repeated). At this time, the power control device 90 simultaneously turns off the output to the vent solenoid to stop venting orthe power control device 90 outputs to the prounital valves of each crane actuator to relieve them individually, so that the movements of the boom 30, the winch 50 and the turn table 20 for crane work are stopped (operation stop output).

Subsequently, when there is no more operation input to all operating systems (YES in S1), the power switching unit 93 controls to drive (supply power) in the initially selected power mode (vehicle engine mode or APU mode) (S2).

After running in the selected power mode (vehicle engine mode or APU mode), the power switching unit 93 stands by for detection (S3) of a touch operation on the APU mode button on the monitor device for switching to the APU mode or for detection (S5) of a touch operation on the vehicle engine mode button on the monitor device for switching to the vehicle engine mode.

When neither touch operation to the APU mode button nor touch operation to the vehicle engine mode button is detected (NO in S3 and NO in S5), the power switching unit 93 continues the power mode that is being driven in S2.

The power switching unit 93 detects touch operation on the APU mode button (YES in S3) and stores the switching that is to the APU mode (S4). At the time of the process of S4, the switch to the APU mode is not performed. The power switching unit 93 detects touch operation on the vehicle engine mode button (YES in S5) and stores the switching that is to the vehicle engine mode (S6). At the time of the process of S6, the switch to vehicle engine mode is not performed.

After storing the switch that is to the APU mode in the process of S4 or after storing the switch that is to the vehicle engine mode in the process of S6, the operation detection unit 91 acquires the presence or absence of an operation input to the operating system, as in the process of S1 (S7).

As a result of the detection by the operation detection unit 91, when the operation presence/absence determination unit 92 determines that there is no operation input to all operating systems (YES in S7), the determination result is output to the power switching unit 93. On the other hand, as a result of the detection by the operation detection unit 91, when the operation presence/absence determination unit 92 determines that there is an operation input to one of the operating systems (NO in S7), the operation presence/absence determination unit 92 stands by until there is no operation input to all operating systems (S7).

When the power switching unit 93 receives a determination result from the operation presence/absence determination unit 92 that there is no operation input to all operating systems (YES in S7), the power switching unit 93 switches the power mode to the APU mode in accordance with the storage of switching to the APU mode stored in the process of S4 (S8) or the memory of switching to the vehicle engine mode stored in the process of S6 (S9), or switches the power mode to the vehicle engine mode in accordance with the storage of switching to the vehicle engine mode stored in the process of S6 (S8). After switching the power mode, the power switching unit 93 returns to the process of S3 and the process of S5, and stands by for a touch operation on the APU mode button or the vehicle engine mode button.

On the other hand, until the power switching unit 93 receives a determination result (YES in S7) from the operation presence/absence determination unit 92 that there is no operation input to all operating systems, the power switching unit 93 continues to drive in the original power mode without switching the power mode regardless of the storage of switching to the APU mode stored in the process of S4 or the storage of switching to the vehicle engine mode stored in the process of S6.

Thus, according to the crane 100 of Example 1, a condition for switching the power supplied to the crane 100 between the vehicle engine 13 and the APU 80 is that there is no operation input to all operating systems for crane work, such as the boom 30 or the winch 50.

Thus, the crane 100 prevents, for example, the boom 30 or the winch 50, which has been operating in the vehicle engine mode, from stopping suddenly when the power supply is cut off at the moment of switching to the APU mode.

In a case where the boom 30 or the winch 50, which has been moving by crane work, suddenly stops, the load suspended by the crane work may swing greatly due to inertia.

However, the crane 100 of Example 1 does not switch from the vehicle engine mode to the APU mode when the boom 30 or the winch 50 is operating (when there is an operation input in the operating system), so the boom 30 or the winch 50 does not stop suddenly, and therefore, it is possible to prevent the occurrence of a situation in which the suspended load swings greatly.

The crane 100 also prevents the boom 30 or the winch 50 that are stopped in the APU mode from suddenly starting to move due to the switch to the vehicle engine mode and the supply of power.

In other words, in the APU mode, since power for crane work is not supplied to the boom 30 or the winch 50, even when there is an operation input to the operating system for crane work, the boom 30 or the winch 50 will not operate. Therefore, in the APU mode, even when there is an operation input to the operating system for crane work, it is not noticed by the operator.

When the operator switches the power mode to the vehicle engine mode without noticing that there is an operation input to the operating system, the boom 30 or the winch 50, which has been stopped in the APU mode, are supplied with power at the moment of switching to the vehicle engine mode, and the boom 30 or the winch 50 may suddenly start moving according to the operation input to the operating system.

However, the crane 100 of Example 1 does not switch from the APU mode to the vehicle engine mode when there is an operation input to the operating system that operates the boom 30 or winch 50, so it is possible to prevent the boom 30 or the winch 50 from suddenly starting to move without the operator's intention.

In the crane 100 of Example 1, during the period when the power control device 90 switches the power mode to the vehicle engine mode, the electric power generated by the vehicle engine 13 allows the outreach amount sensors 15a and 15b to detect the outreach amount of the outriggers 12a and 12b in real time. Therefore, when the crane 100 is in the vehicle engine mode, based on the outreach amount of the outriggers 12a and 12b detected in real time by the outreach amount sensors 15a and 15b, the control device of the crane 100 (not illustrated) can calculate the operating status (e.g., boom 30 posture) and load rate, etc. of the crane 100, and can display the load state, etc., on the monitor device.

On the other hand, in the crane 100, during the period when the power control device 90 switches the power mode to the APU mode, the outreach amount sensors 15a and 15b are not supplied with electric power, so the outreach amount of the outriggers 12a and 12b cannot be detected in real time. However, the memory unit 94 of the power control device 90 stores the outreach amount of the outriggers 12a and 12b detected by the outreach amount sensors 15a and 15b during the period of the vehicle engine mode, immediately prior to the switch to APU mode.

Therefore, when the crane 100 is in the APU mode, based on the outreach amount of the outriggers 12a and 12b stored in the memory unit 94, the APU controller 84 can calculate the operating status (boom 30 posture, etc.) and load rate, etc. of the crane 100, and can display the load state, etc. on the monitor device.

The load state of the crane 100, etc. calculated by the APU controller 84 is not based on the detection values detected in real time from the outreach amount sensors 15a and 15b, and in the APU mode, the outriggers 12 do not operate. Therefore, the outriggers 12 remain the same in the outreach amount from when the outriggers 12 are operating in the vehicle engine mode immediately prior to the switch to the APU mode.

Therefore, in the APU mode, the load state, etc. of the crane 100 calculated based on the outreach amount of outriggers 12a and 12b stored in the memory unit 94 is not inferior in accuracy to that calculated based on the outreach amount detected in real time.

To calculate the load state, etc. of the crane 100, in addition to the outreach amount of the outriggers 12 described above, data such as the extension/retraction length and the raising and lowering angle of the boom 30, the turning angle of the turn table 20, and the load of the suspended load on the wire 51 of the winch 50 are also required, and these data can be obtained in real time by the APU controller 84 in the APU mode.

### Variation of Example 1

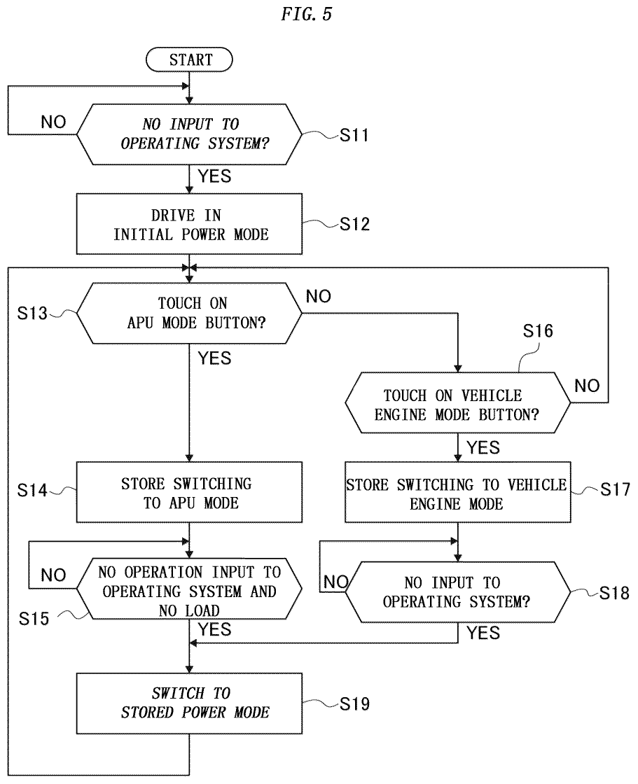

FIG. 5 is a flowchart illustrating one example of the operation of the power control device 90 of a variation of Example 1 in which the crane 100 illustrated in FIGS. 1 and 2 is included. The power control device 90 of Example 1 prevents mutually switching of the power mode between the vehicle engine mode and the APU mode when an operation input is detected for at least one of the operating systems.

In contrast, the flowchart of the variation of the power control device 90 illustrated in FIG. 5 adds, as a predetermined condition for switching from the vehicle engine mode to the APU mode, that there is no load from a suspended load on the wire 51 of the winch 50, i.e., that no load is being suspended by the hook unit 52 to the condition that no operation input is detected for all operating systems. The above additional condition in this variation of the power control device 90 is not included in the predetermined conditions for switching from the APU mode to the vehicle engine mode.

That there is no load on the wire 51 of the winch 50 can be detected, for example, by performing a calculation to convert the reaction force by the operation detection unit 91 based on the detection results from sensors that detect the boom length and the boom angle respectively, the number of hooks on the wire 51 set by the operator's inputting on the monitor device (MFD), and the detection results from sensors that detect the internal pressure of the raising and lowering cylinders.

The operation detection portion 91 handles the detection that there is no load on the wire 51 of the winch 50 in the same way as the operation detection portion 91 handles the detection that there is no operation input to other operating systems, and on the other hand, the operation detection portion 91 handles detection that there is a load on the wire 51 of the winch 50 in the same way as the operation detection portion 91 handles the detection that there is an operation input to other operating systems, so that the operation presence/absence determination portion 92 determines the presence or absence of operation.

The operation of the power control device 90 in the above described variation is illustrated in the flowchart in FIG. 5. The processes from S11 to S14 in the flowchart in FIG. 5 are the same processes corresponding to the processes from S1 to S4 in the flowchart in FIG. 4, and the processes from S16 to S19 in the flowchart in FIG. 5 are the same processes corresponding to the processes from S5 to S8 in the flowchart in FIG. 4. Therefore, the description is omitted.

On the other hand, as described above, as a predetermined condition that the power switching portion 93 switches from the vehicle engine mode to the APU mode, the process of S15 in FIG. 5 determines the detection by the operation presence/absence determination portion 92 that there is no operation input to all operating systems and the detection by the operation presence/absence determination portion 92 that there is no load on the wire 51 of the winch 50, instead of the process of S7 in FIG. 4.

In the process of S15, in a case where the determination result is that no operation input is detected for all operating systems and there is no load on the wire 51 of the winch 50 (YES in S15), the power switching unit 93 performs the process of switching from the vehicle engine mode to the APU mode (S19), and in the process of S15, in a case where an operation input is detected for the operating system or the determination result (NO in S15) is that there is no load on the wire 51 of the winch 50, the power switching unit 93 does not switch the power mode, and the original vehicle engine mode continues.

Thus, even in a case where the stroke holding function of the cylinder is impaired by an internal leak due to damage to the piston seal in the raising and lowering cylinders or the extension and retraction cylinders of the boom 30, the crane 100 of variation can prevent the power mode from being switched to the APU mode by adding to the predetermined conditions that there is no load on the wire 51 of the winch 50 as a predetermined condition for switching from the vehicle engine mode to the APU mode.

In other words, in the vehicle engine mode, power can be provided to the winch 50 to raise and lower the wire 51. Thus, even in a case where the crane 100 falls into a situation where the stroke holding function of the raising and lowering cylinders or the extension and retraction cylinders of the boom 30 is impaired and the boom 30 starts to go down or shorten, it is possible to reduce the load state of the crane 100 by quickly landing the suspended load by unrolling the wire 51. In contrast, the crane 100 can also wind up the wire 51 to prevent the suspended load from landing or slow the speed of landing to suppress the impact applied to the suspended load.

### EXAMPLE 2

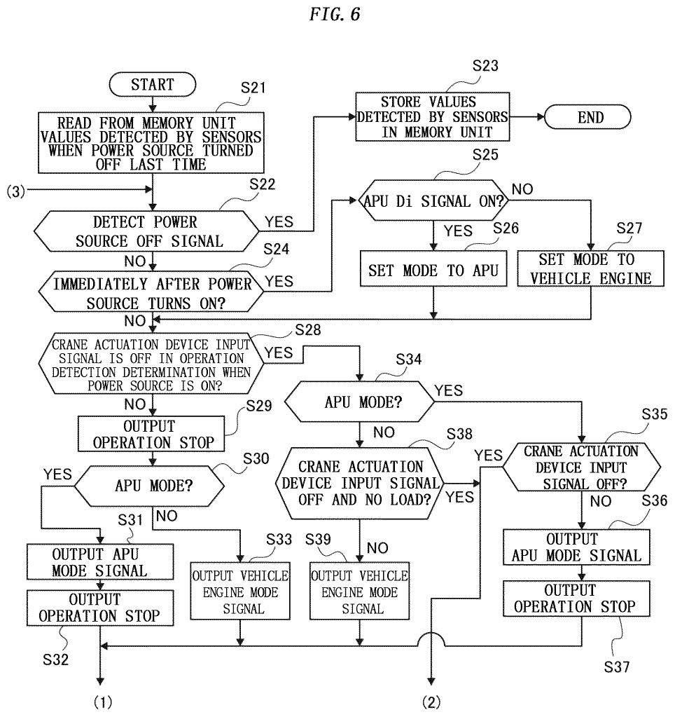

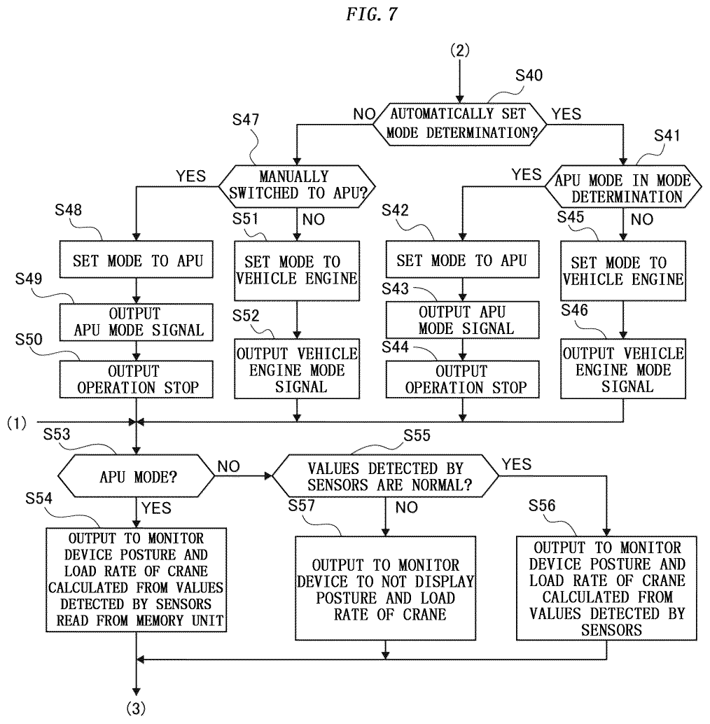

FIG. 6 is a flowchart (Part 1) illustrating the operation of the power control device 90 in Example 2 in which the crane 100 illustrated in FIGS. 1 and 2 is included, and FIG. 7 is a flowchart (Part 2) illustrating the operation of the power control device 90 in Example 2.

The power control device 90 in Example 1 allows the operator to manually select either the vehicle engine mode or the APU mode, and switches to the manually selected power mode when specified conditions are met.

In contrast, the power control device 90 of Example 2 has two power modes that can be selected by the operator: vehicle engine mode and APU mode, as in Example 1, and in addition to manual switching, the power control device 90 of Example 2 also has an automatic switching mode that automatically switches to APU mode when specific conditions are met in the vehicle engine mode. The automatic switching mode is selectable on the monitor device as an icon for the automatic switching mode button, similar to the manual switching vehicle engine mode and the manual switching APU mode.

In other words, the monitor device displays three selectable switches: an icon for the vehicle engine mode button for manual switching, an icon for the APU mode button for manual switching, and an icon for the automatic switching mode button for automatic switching.

When the automatic switching mode is selected by touching the icon for the automatic switching mode button, the power control device 90 controls the switching of the power mode from the vehicle engine mode to the APU mode when specific conditions are met. Here, the specific conditions are, for example, that the operating system for crane work continues for a certain period of time (e.g., 20 minutes or more) without any operation input. The specific conditions are not limited to that the operating system for crane work continues for a certain period of time (e.g., 20 minutes or more) without any operation input, and other conditions may be applied.

In the automatic switching mode, the power control device 90 does not unconditionally switch from the vehicle engine mode to the APU mode when the specific conditions described above are met, but, as in the case of Embodiment 1 and the variation, a precondition is that the predetermined condition of no operation input to all operating systems is met.

In the crane vehicle according to the present invention, the specific conditions in which the automatic switching mode switches the power mode from the vehicle engine mode to the APU mode are not limited to the case where the above-described no-operation condition continues for a certain period of time.

The power control device 90 in the crane 100 of Example 2 configured in this manner performs processes as illustrated in the flowcharts in FIGS. 6 and 7.

The crane 100 of the second embodiment first turns on the power source by the vehicle engine mode or the APU mode (START). At this stage, the crane 100 is supplied with electric power only for the process of setting the power mode, either in the vehicle engine mode or in the APU mode. In the vehicle engine mode, the vehicle engine 13 provides power, and when the PTO is connected to the vehicle engine 13, also provides power for crane work.

After the power source is turned on, the power control device 90 reads the values which is detected by the outreach amount sensors 15a and 15b of the outriggers 12, and have been stored in the memory unit 94 when the power source was turned off the last time (S21).

Next, the power control device 90 detects whether the power source has been turned off (S22). When the power control device 90 detects that the power source has been turned off (YES in S22), the power control device 90 stores the values detected by the outreach amount sensors 15a and 15b in the memory unit 94 (S23), the power control device 90 turns off the power source and ends the process (END).

When the power control device 90 does not detect that the power source has been turned off (NO in S22), the power control device 90 determines whether or not the power source has immediately been turned on (S24). When the power control device 90 performs this determination for the first time after the power source is turned on, the power control device 90 determines that it is immediately after the power source is turned on (YES in S24), and when the power control device 90 performs this determination for the second time after the power source is turned on, the power control device 90 determines that it is not immediately after the power source is turned on (NO in S24).

When the power control device 90 determines that the power source has immediately been turned on (YES in S24), the power control device 90 determines whether or not the first power source is turned on in APU mode (S25). When the power control device 90 determines that the first power source is turned on in APU mode (YES in S25), the power control device 90 sets the power mode to APU mode (S26). At this time, the power control device 90 only stores that it is the APU mode and does not supply power in the APU mode.

On the other hand, when the power control device 90 determines that the first power source is not turned on in APU mode (NO in S25), the power control device 90 sets the power mode to vehicle engine mode (S27). At this time, the power control device 90 only stores that it is the vehicle engine mode and does not provide actual power in the vehicle engine mode.

When the power control device 90 determines in the process of S24 that the power source has not been turned on immediately (NO in S24) and sets the power mode by the process of S26 or the process of S27, the operation detection unit 91 of the power control device 90 then determines whether or not there is no operation input to the operating system for crane work (crane actuation device input signal OFF) (S28).

When the power control device 90 determines that there is an operation input to the operating system (NO in S28), the power control device 90 forcibly turns off the operation input to the operating system and enters a state where there is no operation input to the operating system (S29). Thereafter, the power control device 90 determines whether or not the power mode stored in the process of S26 or the process of S27 is the APU mode (S30).

When the power mode stored by the power control device 90 is the APU mode according to the process of S26 (YES in S30), the power switching unit 93 of the power control device 90 outputs the APU mode signal to start supplying mechanical power and electric power by the APU 80 to start the APU mode (S31). The power control device 90 then forcibly sets the operation input to the operating system to turn off (S32). Thereafter, the power control device 90 proceeds to the process of S53 illustrated in FIG. 7.

Here, the power control device 90 forcibly sets the operation input to the operating system to turn off (S32), but this process of forcibly turning off the operation input to the operating system is a process to disable the actual crane work operation in the APU mode, even when there is an operation to the operating system, and is not a process for the condition to switch the power mode to the APU mode.

The process of S37, the process of S44, and the process of S50 described below, in which the power control device 90 forcibly sets the operation input to the operating system to turn off, are also performed for the same reason as the process of S32, and are not processes for the condition of switching the power mode to APU mode.

When the power mode stored by the power control device 90 is the vehicle engine mode according to the process of S27 (NO in S30), the power switching unit 93 of the power control device 90 outputs a vehicle engine mode signal to start supplying mechanical power and electric power by the vehicle engine 13 to start the vehicle engine mode (S33). Thereafter, the power control device 90 proceeds to the process of S53 illustrated in FIG. 7.

When the power control device 90 determines in the process of S28 that there is no operation input to the operating system (YES in S28), the power control device 90 determines whether the power mode stored in the process of S26 or the process of S27 is the APU mode (S34).

When the power mode stored by the power control device 90 is the APU mode by the process of S26 (YES in S34), the power control device 90 determines whether or not there is an operation input to the operating system for crane work (crane actuator input signal OFF) (S35).

When the power control device 90 determines that there is an operation input to the operating system (NO in S35), the power switching unit 93 of the power control device 90 outputs an APU mode signal to start supplying mechanical power and electric power by the APU 80 to start the APU mode (S36). The power control device 90 then forcibly sets the operation input to the operating system to turn off (S37) and proceeds to the process of S53 described later in FIG. 7.

When the power control device 90 determines that there is no operation input to the operating system (YES in S35), the power control device 90 proceeds to the process of S40 described later in FIG. 7, which is the determination process of the automatic switching mode.

In the process of S34, when the power mode stored by the power control device 90 is the vehicle engine mode by the process of S27 (NO in S34), it is determined whether or not there is no operation input to the operating system for crane work and there is no load on the wire 51 (crane operating system input signal OFF and no load) (S38).

When the power control device 90 determines that there is no operation input to the operating system or no load (NO in S38), the power switching unit 93 of the power control device 90 outputs a vehicle engine mode signal to start supplying mechanical power and electric power by the vehicle engine 13 to start the vehicle engine mode (S39), and proceeds to the process of S53 described later in FIG. 7.

When the power control device 90 determines that there is no operation input to the operating system and no load (YES in S38), the power control device 90 proceeds to the S40 process described later in FIG. 7, which is the determination process of the automatic switching mode.

When the power control device 90 determines that there is no operation input to the operating system (YES in S35) in the APU mode (YES in S34), or when the power control device 90 determines that there is no operation input to the operating system and no load (YES in S38) in the vehicle engine mode (NO in S34), the power control device 90 proceeds to the process of S40 illustrated in FIG. 7.

Here, processes after S40 (processes in which the number of S is 40 or more) indicate the operation when the power mode is switched from the power mode at the time the power source is first turned on to the other power mode. In other words, the processes after S40 are processes in a case where the operator touches one of the vehicle engine mode button, the APU mode button, or the automatic switching mode button displayed on the monitor device.

First, the power control device 90 determines whether the automatic switching mode button is selected among the three power mode buttons displayed on the monitor device (S40).

When the power control device 90 determines that the automatic switching mode button has been selected (automatic mode determination setting) (YES in S40), the power control device 90 determines whether the switching by automatic switching mode should be set to the APU mode that meets the specific conditions (S41).

When the power switching unit 93 of the power control device 90 determines that the switching should be set to the APU mode (YES in S41), the power switching unit 93 sets the power mode to the APU mode (S42). At this time, the power control device 90 only stores that it is the APU mode and does not switch to the APU mode.

Thereafter, the power switching unit 93 of the power control device 90 corresponds the power mode to the stored APU mode and outputs an APU mode signal to start supplying mechanical power and electric power by the APU 80 to start the APU mode (S43). The power control device 90 then forcibly sets the operation input to the operating system to turn off (S44). Thereafter, the power control device 90 proceeds to the process of S53.

When the power switching unit 93 of the power control device 90 determines that the power mode should not be set to APU mode because the specific conditions are not met (NO in S41), the power switching unit 93 sets the power mode to the vehicle engine mode (S45). At this time, the power control device 90 only stores that it is the vehicle engine mode and does not switch to vehicle engine mode.

Thereafter, the power switching unit 93 of the power control device 90 corresponds the power mode to the stored vehicle engine mode and outputs a vehicle engine mode signal to start supplying mechanical power and electric power by the vehicle engine 13 to start the vehicle engine mode (S46). Thereafter, the power control device 90 proceeds to the process of S53.

When the power control device 90 determines in the process of S40 that the automatic switching mode button is not selected (NO in S40), the power control device 90 further determines whether the APU mode button is selected (manually switched to APU) (S47).

When the power switching unit 93 of the power control device 90 determines in the process of S47 that the APU mode button is selected (YES in S47), the power switching unit 93 sets the power mode to the APU mode (S48). At this time, the power control device 90 only stores that it is the APU mode and does not switch to the APU mode.

Thereafter, the power switching unit 93 of the power control device 90 outputs an APU mode signal to start supplying mechanical power and electric power by the APU 80, corresponding to the stored APU mode, to start the APU mode (S49). The power control device 90 then forcibly sets the operation input to the operating system to turn off (S50). The condition for the power switching unit 93 of the power control device 90 to switch the power mode to the APU mode, i.e., no operation input to the operating system, is met by the process of S35 or the process of S38. Thereafter, the power control device 90 proceeds to the process of S53.

When the power switching unit 93 of the power control device 90 determines in the process of S47 that the vehicle engine mode button is selected (NO in S47), the power switching unit 93 sets the power mode to the vehicle engine mode (S51). At this time, the power control device 90 only stores that it is the vehicle engine mode and does not switch to vehicle engine mode.

Thereafter, the power switching unit 93 of the power control device 90 corresponds the power mode to the stored vehicle engine mode and outputs a vehicle engine mode signal to start supplying mechanical power and electric power by the vehicle engine 13 to start the vehicle engine mode (S52). Thereafter, the power control device 90 proceeds to the process of S53.

The power control device 90 determines in the process of S53 whether or not the current power mode is the APU mode. When the power control device 90 determines that the power mode is the APU mode (YES in S53), the power control device 90 reads from the memory unit 94 the values detected by the outreach amount sensors 15a and 15b of the outriggers 12 that are stored in the memory unit 94 immediately before the switch from the vehicle engine mode to the APU mode, calculates the operating status (e.g., boom 30 posture) and load state such as load rate of the crane 100 based on the read values, and outputs the calculated results to the monitor device (S54). Thereafter, the power control device 90 returns to the process of S22.

When the power control device 90 determines in the process of S53 that the current power mode is not the APU mode (NO in S53), since the power mode is the vehicle engine mode, the power control device 90 determines whether or not the real-time outreach amount sensors 15a and 15b of the outriggers 12 at the current time are functioning normally (S55). The power control device 90 determines that the outreach amount sensors 15a and 15b are functioning normally when the output values of the outreach amount sensors 15a and 15b are within the rated range and determines that the outreach amount sensors 15a and 15b are not functioning normally when the output values are not within the rated range.

When the power control device 90 determines in the process of S55 that the outreach amount sensors 15a and 15b are functioning normally (YES in S55), the power control device 90 calculates the operating status (e.g., boom 30 posture) and load state such as load rate of the crane 100 based on the values detected in real time by the outreach amount sensors 15a and 15b of outriggers 12, and outputs the calculated results to the monitor device (S56). Thereafter, the power control device 90 returns to the process of S22.

When the power control device 90 determines in the process of S55 that the outreach amount sensors 15a and 15b are not functioning normally (NO in S55), the power control device 90 does not calculate the operating status (e.g., boom 30 posture.) and load state such as load rate of the crane 100, and does not control to display on the monitor device (S57). Thereafter, the power control device 90 returns to the process of S22.

As described in detail above, according to the power control device 90 of Example 2, as in Example 1 and the variation, a condition for switching the power supplied to the crane 100 between the vehicle engine 13 and the APU 80 is that there is no operation input to all operating systems for crane work, such as the boom 30 or the winch 50.

Therefore, the crane 100 of Example 2, for example, prevents the boom 30 or the winch 50, which has been operating in the vehicle engine mode, from stopping suddenly when the power supply is cut off at the moment of switching to the APU mode.

The crane 100 of Example 2 also prevents the boom 30 or the winch 50 from stopping in the APU mode and suddenly starting to move due to the switch to the vehicle engine mode and the supply of power.

The crane 100 in Example 2 also allows the display of the load state etc. on the monitor device by the APU controller 84 calculating the operating status (e.g., boom 30 posture) and load state such as load rate of the crane 100 based on the outreach amounts of outriggers 12a and 12b detected by the outreach amount sensors 15a and 15b during the period of the vehicle engine mode, immediately prior to switching to the APU mode, when the power control device 90 switches the power mode to the APU mode.

The power control device 90 of Example 2 is not limited to the case of manual switching of the power mode, but can also be used in the automatic switching mode to prevent a situation in which the power supply is cut off at the moment of switching to the APU mode, causing a sudden stop.

The power control device 90 in Example 2 is a power mode in which the automatic switching mode automatically switches from the vehicle engine mode to the APU mode, and a power mode that automatically switches from the APU mode to the vehicle engine mode can also be applied, or the power modes can be automatically switched to each other.

The power control device 90 of Example 2 forcibly sets the operation input to the operating system to turn off when switching to APU mode (each process of S32, S37, S44, and S50), and the power control device 90 of Example 2 may apply a process that forcibly sets the operation input to the operating system to turn off under predetermined conditions, even in a case of switching to the vehicle engine mode.

### REFERENCE SIGNS LIST

10 Traveling device
13 Vehicle engine (main power unit)
20 Turn table
30 Boom
40 Cabin (cockpit)
80 APU (auxiliary power unit)
90 Power control device
100 Rough terrain crane (crane vehicle)

1. A crane vehicle comprising:
a traveling device;
a turn table that is disposed above the traveling device and turnable with respect to the traveling device;
a boom and a cockpit that are provided on the turn table;
a main power unit that is provided in the traveling device and supplies power to the traveling device, the boom and the cockpit;
an auxiliary power unit that is provided on the turn table and does not supply power to the traveling device and the boom, but supplies power to the cockpit; and
a processor that selectively switches between a main power mode supplied with power from the main power unit and an auxiliary power mode supplied with power from the auxiliary power unit, wherein
the processor disables a switching between the main power mode and the auxiliary power mode when an operation input to an operating system that operates the boom is detected, and the processor enables a switching between the main power mode and the auxiliary power mode when an operation input to the operating system is not detected.

2. The crane vehicle according to claim 1, wherein
the processor disables a switching from the main power mode to the auxiliary power mode when a load from a suspended load on the boom is detected or when an operation input to the operating system is detected, and
the processor enables a switching from the main power mode to the auxiliary power mode when a load from a suspended load on the boom is not detected and when an operation input to the operating system is not detected.

3. The crane vehicle according to claim 1, wherein
in an automatic switching mode set to switch between the main power mode and the auxiliary power mode when specific conditions are met, the processor disables a switching between the main power mode and the auxiliary power mode when an operation input to an operating system that operates the boom is detected, and the processor enables a switching between the main power mode and the auxiliary power mode when an operation input to the operating system is not detected.

4. The crane vehicle according to claim 1 further comprising:
an outreach amount sensor that detects an outreach amount of an outrigger provided on the traveling device in the main power mode; and
a memory that stores the outreach amount detected by the outreach amount sensor in the main power mode, wherein
the processor calculates a load state of the crane based on the outreach amount stored in the memory in the auxiliary power mode.

5. The crane vehicle according to claim 3 further comprising:
an outreach amount sensor that detects an outreach amount of an outrigger provided on the traveling device in the main power mode; and
a memory that stores the outreach amount detected by the outreach amount sensor in the main power mode, wherein
the processor calculates a load state of the crane based on the outreach amount stored in the memory in the auxiliary power mode.
